(19) United States
(12) Patent Application Publication
(10) Pub. No.: US 2024/0199937 A1
(43) Pub. Date: Jun. 20, 2024

(54) NANOPARTICLE COMPOSITES FOR USE AS AN INSULATION AND METHODS OF MAKING THEREOF

(71) Applicant: The Regents of the University of California, Oakland, CA (US)

(72) Inventors: Sumanjeet Kaur, Pinole, CA (US); Ravi S. Prasher, Danville, CA (US); Sean Lubner, Cambridge, MA (US)

(21) Appl. No.: 18/519,315

(22) Filed: Nov. 27, 2023

Related U.S. Application Data
(60) Provisional application No. 63/426,838, filed on Dec. 2, 2022.

(51) Int. Cl. C09K 5/14

(52) U.S. Cl. CPC C09K 5/14

(57) ABSTRACT

This disclosure provides systems, methods, and apparatus related to thermal insulation. In one aspect, a composite includes a plurality of silica nanoparticles and a plurality of first nanoparticles. The plurality of silica nanoparticles comprise about 70 wt % to 98 wt % of the composite. The plurality of first nanoparticles comprising about 2 wt % to 30 wt % of the composite.

### RELATED APPLICATIONS

This application claims priority to U.S. Provisional Patent Application No. 63/426,838, filed Dec. 2, 2022, which is herein incorporated by reference.

### STATEMENT OF GOVERNMENTAL SUPPORT

The invention was made with government support under Contract Nos. DE-AC02-05CH11231 awarded by the U.S. Department of Energy. The government has certain rights in the invention.

### TECHNICAL FIELD

This disclosure related generally to thermal insulation.

### BACKGROUND

At present, commonly used conventional insulations such as fiberglass, rock wool. expanded polystyrene (EPS), extruded polystyrene (XPS), polyisocyanurate, and cellulose are relatively inexpensive but are too thick and labor intensive to be cost-effective for many applications, including retrofit projects in building sector. Other emerging insulation solutions, such as aerogel and vacuum-insulated panels, have high R/inch values but at a much higher cost.

Aerogel, the world's lightest solid material, typically contains 95% to 99% air by volume. It is made using a sol-gel process whereby a highly porous solid network is achieved by replacing the liquid inside the material's pores with gas. The process requires super critical drying. Super critical drying is used to avoid the creation of capillary forces, which would collapse the highly porous and fragile solid network during evaporation of the liquid phase. This integral step is also the primary barrier to commercialization of aerogel because it requires high temperatures and/or high pressures that consume large amounts of energy. The high-energy requirements and the batch processing of aerogel limit the scaling up of aerogel manufacturing, which continues to make it expensive. In addition, aerogel's low volume fraction of solids (about 1% to 5%) makes it fragile and difficult to handle unless it is integrated or reinforced with a fibrous matrix. Silica aerogel in its pristine form can have a thermal conductivity as low as 0.01 W/mK, but when integrated with a fibrous matrix for practical applications, the thermal conductivity of the final product increases to 0.014 W/mK to 0.020 W/mK.

Vacuum-insulated panels (VIPs) comprise an open-pore core material that is vacuum enveloped by foil that prevents the entry of air and water. Since the R/inch value of VIPs is about R20 to R45, a thin (e.g., 9 millimeters (mm)) VIP can provide thermal insulation equivalent to thick mats (about 76 mm to 100 mm) of conventional insulation materials, but it suffers from limitations. Because they are vacuum-enveloped, VIPs come in precut forms and cannot be cut or modified at the building site, making them generally unsuitable for retrofits, which typically require a custom fit. VIPs also are vulnerable to being punctured by nails or screws, which could decrease their R/inch value to around 7. In addition, the performance of VIPs tends to decline over time because the foil is not completely impermeable to air and moisture.

There is no insulation in the market that can cost-effectively render building envelope energy efficient.

### BRIEF DESCRIPTION OF THE DRAWINGS

FIG. 1 shows an example of a cross-sectional schematic illustration of the composite thermal insulation.

FIG. 2 shows an example of a flow diagram illustrating a manufacturing process for a composite thermal insulation.

FIG. 3 shows an example of a schematic diagram of a silane treatment.

FIG. 4 shows an example of a cross-sectional schematic illustration of the composite thermal insulation.

FIG. 5 shows a graph illustrating the effect of surface energy, acoustic mismatch, and nanoparticle size for a packed bed of randomly distributed alumina nanoparticles (volume fraction about 0.6).

FIG. 6 shows the thermal conductively of a number of different thermal insulation composites.

FIG. 7 shows the effect of the ratio of silica/carbon black on the thermal conductivity of a thermal insulation composite.

FIG. 8A shows an example of rigid insulation made using one method. FIG. 8B shows an example of flexible insulation made by integrating glassfibers in the method.

FIG. 9 shows the thermal insualtion properties of both the rigid insulation and the flexible insulation shown in FIGS. 8A and 8B, respectively.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Described herein is a thermal insulation based on a packed bed of nanoparticles. where the low thermal conductivity is attained by manipulating heat transfer at interfaces. Interfaces between materials create discontinuity in the heat flow because phonons are scattered at the interfaces. In the case of nanomaterials, the high density of interfaces makes it possible to attain low thermal conductivity. Theoretically, it has been shown that the effective mean free path (m.f.p.) of phonons for two nanoparticles in contact with each other is given by:

$${l}_{eff} = 3 \frac{{α}^{2}}{R} \int τ sin ( θ ) cos ( θ ) d θ \qquad ( 1 )$$

where α is the constriction radius, R is the radius of the nanoparticle, and τ is the transmissivity of the phonons. Thermal conductivity, k, is given by (1/3)cvl where c is the specific heat per unit volume, v is the Debye speed (velocity of phonons), and l is the m.f.p. a²/R in Eq. (1) is given by (1.125πγ/E)^{2/3}R^{1/3} where γ is the surface energy and E is the effective modulus. α²/R can be very small for nanoparticle depending on γ, E, and R. It has been shown that τ in Eq. (1) is a function of γ and acoustic properties of the nanoparticles. For smaller values of γ, τ can be very small.

Eq. (1) shows that the parameters that can be specified to obtain low thermal conductivity are: (1) surface energy; (2) nanoparticle size; and (3) acoustic property mismatch by mixing different types of nanoparticles. By replacing solid nanoparticles with hollow nanoparticles, the thermal conductivity can be further reduced by keeping the inner diameter of the hollow nanoparticles closer to and/or smaller than the mean free path of air (Knudson Effect).

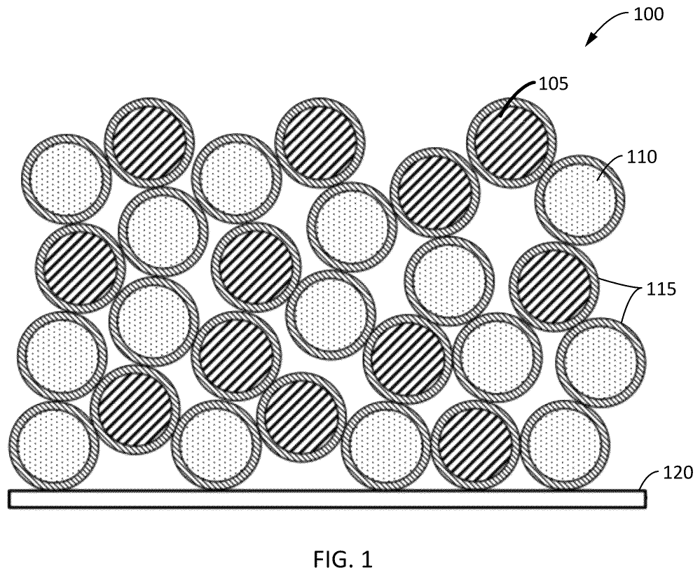

FIG. 1 shows an example of a cross-sectional schematic illustration of the composite thermal insulation. As shown in FIG. 1, a composite 100 include a plurality of silica nanoparticles 105 and plurality of first nanoparticles 110. In some embodimets, first nanoparticles of the plurality of first nanoparticles 110 are not silica nanoparticles. In some embodiments, the plurality of silica nanoparticles comprise about 70 wt % to 98 wt % of the composite. In some embodiments, the plurality of first nanoparticles comprise about 2 wt % to 30 wt % of the composite. A thickness of the composite 100 is about 0.25 inches to 3 inches thick. Such thickness of the composite could be used for bulk thermal insulation.

In some embodiments, the silica nanoparticles and the first nanoparticles are uniformly sized nanoparticles or a specified distribution of different sizes. In some embodiments, the diameters or sizes of some nanoparticles can be tuned to scatter photons with the thermal wavelengths most produced by the target operating temperatures of the object to be thermally insulated. This is of particular utility for high temperature applications, where heat transfer by radiation may be comparable to or greater than heat transfer by conduction and convection. In some embodiments, silica nanoparticles of the plurality of silica nanoparticles have dimensions of about 3 nanometers (nm) to 300 nm. In some embodiments, first nanoparticles of the plurality of first nanoparticles have dimensions of about 3 nanometers (nm) to 300 nm.

In some embodiments, silica nanoparticles of the plurality of silica nanoparticles are hollow silica nanoparticles. In some embodiments, silica nanoparticles of the plurality of silica nanoparticles are solid silica nanoparticles. In some embodiments, first nanoparticles of the plurality of first nanoparticles are hollow first nanoparticles. In some embodiments, first nanoparticles of the plurality of first nanoparticles are solid first nanoparticles. In some embodiments, when a nanoparticle is a hollow nanoparticle (e.g., either or both of the silica nanoparticles and the first nanoparticles being hollow nanoparticles), an inner hollow diameter of the nanoparticle is about 3 nm to 300 nm. In some embodiments, a thickness of a shell of a hollow nanoparticle is about 3 nm to 3 microns, or about 30 nm.

In some embodiments, a packing density of the nanoparticles is about 10% to 60%. Varying the packing density can be used to adjust the trade-off between thermal insulation versus weight and mechanical properties, based on the specified insulation application. The packing density of the nanoparticles depends in part on the nanoparticle shape, uniformity of nanoparticle shapes, nanoparticle size distribution, and assembly method of the nanoparticles.

In some embodiments, each silica nanoparticle of the plurality of silica nanoparticles has a morphology that is spherical to branched to randomly shaped. In some embodiments, cach nanoparticle of the plurality of silica nanoparticles has a surface area of about 10 m²/g to 800 m²/g. In some embodiments, each first nanoparticle of the plurality of first nanoparticles has a morphology that is spherical to branched to randomly shaped. In some embodiments, each nanoparticle of the plurality of first nanoparticles has a surface area of about 10 m²/g to 800 m²/g.

In some embodiments, the plurality of first nanoparticles are nanoparticles from a group carbon, alumina, titania, magnesia, zirconia, silicon nitride, iron oxide, and an oxide ore. In some embodiments, the plurality of first nanoparticles are polymer nanoparticles (e.g., polystyrene nanoparticles or polyurethane nanoparticles). A first nanoparticle material can be specified so that the atomic lattice vibrational frequency spectra is different of that of the silica nanoparticles. In such instances, the resulting acoustic mismatch between the phonon densities of states among the nanoparticles comprising different materials reduces the transmission rate of phonons from one nanoparticle to another of dissimilar material, increasing thermal contact resistance among the nanoparticles, in turn enhancing the thermal insulation.

In some embodiments, the nanoparticles (e.g., either or both of the silica nanoparticles and the first nanoparticles) have low thermal conductivity. In some embodiments, the nanoparticles (e.g., either or both of the silica nanoparticles and the first nanoparticles) are rigid, so as to minimize the deformation where nanoparticles contact each other, thus reducing the contact area and hence further increasing thermal contact resistances, in turn enhancing the thermal insulation.

In some embodiments, the composite has a density of about 5 lbs/cubic feet to 40 lbs/cubic feet. In some embodiments, the composite has a thermal conductivity of about 0.009 W/m·K to 0.026 W/m·K.

In some embodiments, the nanoparticles (e.g., either or both of the silica nanoparticles and the first nanoparticles) have a surface coating generated via chemical functionalization of the surfaces of the nanoparticles. The coating is depicted as the shell 115 on the silica nanoparticles and the first nanoparticles shown in FIG. 1. Such surface functionalization can reduce the surface energy of the nanoparticles and reduce the effective spring constant of the inter-particle forces keeping the nanoparticles bound together. These effects further reduce the rate of phonon transmission among nanoparticles, further enhancing the thermal insulation. Such functionalization may also make the nanoparticle surface hydrophobic.

In some embodiments, at least a portion of the silica nanoparticles of the plurality of silica nanoparticles are covalently bonded to one or more silane molecules. In some embodiments, the silane molecules have the following structure:

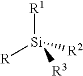

R and R¹ are each independently —(CH₂)ₙ—R⁴. R⁴ is —X, —O—CH₃, or —OH. R² and R³ are each independently —X. —CH₃, or —NH₂. n is an integer from 1 to 20. X is a halogen. One of R² or R³ of the silane is replaced with a covalent bond to an ether group which in turn is covalently bonded to a silica nanoparticle. In some embodiments, the halogen is fluorine, chlorine, or bromine.

In some embodiments, chemical functionalization on the surfaces of the nanoparticles can be performed by wet chemistry or a vapor phase process in which chemicals are bound to the surfaces of the nanoparticles, where the end groups is X. —CX₃, —CHX₂, —CH₂X, —CH₃, —NH₂, or the like, and where X is a halogen, such as F, Cl, or Br. This surface functionalization for the purpose of reducing inter-particle phonon transmission rates is an important aspect of the thermal insulation design and has a significant impact on lowering the effective thermal conductivity of the nanoparticle bed.

In some embodiments, at least a portion of the first nanoparticles of the plurality of first nanoparticles are covalently bonded to one or more silane molecules. In some embodiments, the silane molecules have the following structure:

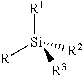

R and R¹ are each independently —(CH₂)ₙ—R⁴. R⁴ is —X, —O—CH₃, or —OH. R² and R³ are each independently —X, —CH₃, or —NH₂. n is an integer from 1 to 20. X is a halogen. One of R² or R³ of the silane is replaced with a covalent bond to an ether group which in turn is covalently bonded to a first nanoparticle. In some embodiments, the halogen is fluorine, chlorine, or bromine.

Returning to FIG. 1, in some embodiments, the composite is disposed on a layer of material 120. In some embodiments, the layer of material is a layer of material from a group a metal foil, polydimethylsiloxane (PDMS), glass fiber reinforced cellulosic felt, glass fiber, and coated or uncoated polymer bonded glass fiber matt. In some embodiments, the layer of material is metal foil that is aluminum foil. In some embodiments, the layer of material (one side or both sides) has a low emissivity material disposed thereon. Such a low emissivity material can act as thermal radiation shield, reducing the amount of heat transferred through the composite as thermal radiation. In some embodiments, the low emissivity material is about 30 nm to 500 nm thick. In some embodiments, the low emissivity material is aluminum or nickel.

In some embodiments, the composite further includes a plurality of second nanoparticles (not shown). In some embodiments, the plurality of second nanoparticles comprise about 1 wt % to 10 wt % of the composite, with the plurality of second nanoparticles being a different composition than the plurality of first nanoparticles and further not being silica nanoparticles. In some embodiments, the plurality of second nanoparticles are nanoparticles from a group carbon, alumina, titania, magnesia, zirconia, silicon nitride, iron oxide, and an oxide ore. In some embodiments, the plurality of second nanoparticles are polymer nanoparticles (e.g., polystyrene nanoparticles or polyurethane nanoparticles). In some embodiments, second nanoparticles of the plurality of second nanoparticles are hollow second nanoparticles. In some embodiments, second nanoparticles of the plurality of second nanoparticles are solid second nanoparticles. In some embodiments, second nanoparticles of the plurality of second nanoparticles have dimensions of about 3 nm to 300 nm. In some embodiments, each nanoparticle of the plurality of second nanoparticles has a morphology that is spherical to branched to randomly shaped. In some embodiments, each nanoparticle of the plurality of second nanoparticles has a surface area of about 10 m²/g to 800 m²/g.

In some embodiments, at least a portion of the second nanoparticles of the plurality of second nanoparticles are covalently bonded to one or more silane molecules. In some embodiments, the silane molecules have the following structure:

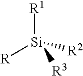

R and R¹ are each independently —(CH₂)ₙ—R⁴. R⁴ is —X, —O—CH₃, or —OH. R² and R³ are each independently —X, —CH₃, or —NH₂. n is an integer from 1 to 20. X is a halogen. One of R² or R³ of the silane is replaced with a covalent bond to an ether group which in turn is covalently bonded to a first nanoparticle. In some embodiments, the halogen is fluorine, chlorine, or bromine.

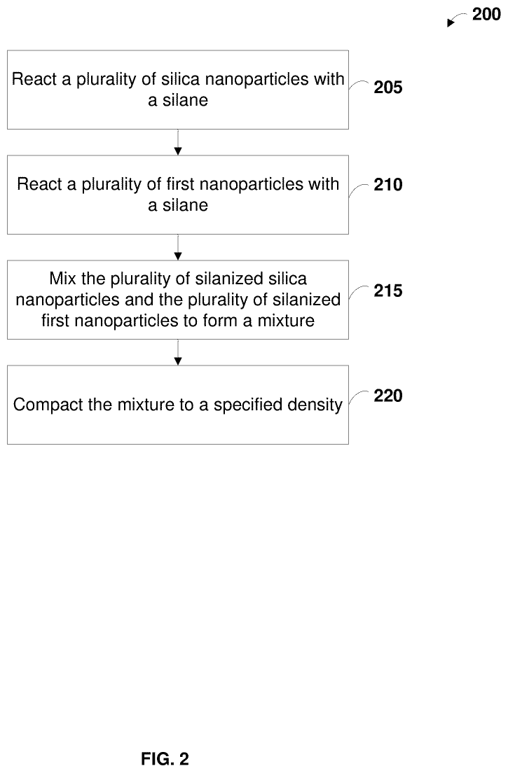

FIG. 2 shows an example of a flow diagram illustrating a manufacturing process for a composite thermal insulation. Any of the composite thermal insulations described herein may be fabricated using the process described with respect to FIG. 2. Starting at block 205 of the process 200, a plurality of silica nanoparticles is reacted with a silane having the structure of

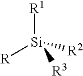

R and R¹ are each independently —(CH₂)ₙ—R⁴. R⁴ is —X, —O—CH₃, or —OH. R² and R³ are each independently —X, —CH₃, or —NH₂. n is an integer from 1 to 20. X is a halogen. The reaction is performed using gas phase surface chemistry to generate a plurality of silanized silica nanoparticles. One of R² or R³ of the silane is replaced with a covalent bond to an ether group which in turn is covalently bonded to a silica nanoparticle.

At block 210, a plurality of first nanoparticles is reacted with a silane having the structure of

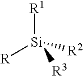

R and R¹ are each independently —(CH₂)ₙ—R⁴. R⁴ is —X, —O—CH₃, or —OH. R² and R³ are each independently —X, —CH₃, or —NH₂. n is an integer from 1 to 20. X is a halogen. The reaction is performed using gas phase surface chemistry to generate a plurality of silanized first nanoparticles. One of R² or R³ of the silane is replaced with a covalent bond to an ether group which in turn is covalently bonded to a first nanoparticle.

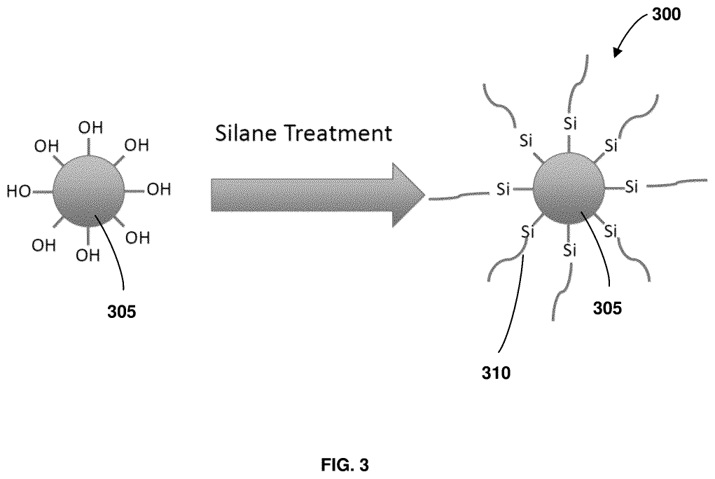

FIG. 3 shows an example of a schematic diagram of a silane treatment. As shown in FIG. 3, after a silane treatment 300, a nanoparticle 305 has silane molecules 310 bonded to the nanoparticle 305.

Turning back to FIG. 2, at block 215, the plurality of silanized silica nanoparticles and the plurality of silanized first nanoparticles are mixed to form a mixture. The plurality of silanized silica nanoparticles comprise about 70 wt % to 98 wt %, and the plurality of silanized first nanoparticles comprise about 2 wt % to 30 wt %.

At block 220, the mixture is compacted to a specified density. In some embodiments, the compacting comprises compacting using a pressure of about 50 psi to 150 psi. In some embodiments, the specified density is about 5 lbs/cubic feet to 40 lbs/cubic feet.

In some embodiments, the process 400 further includes reacting a plurality of second nanoparticles with a silane having the structure of

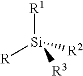

R and R¹ are cach independently —(CH₂)ₙ—R⁴. R⁴ is —X, —O—CH₃, or —OH. R² and R³ are cach independently —X, —CH₃, or —NH₂. n is an integer from 1 to 20. X is a halogen. The reaction is performed using gas phase surface chemistry to generate a plurality of silanized first nanoparticles. One of R² or R³ of the silane is replaced with a covalent bond to an ether group which in turn is covalently bonded to a second nanoparticle.

The plurality of second nanoparticles are a different composition than the plurality of first nanoparticles and are not silica nanoparticles. If a plurality of second nanoparticles is included in the composite, the mixing at block 215 includes mixing the plurality of silanized second nanoparticles, with the plurality of silanized second nanoparticles comprising about 1 wt % to 10 wt %.

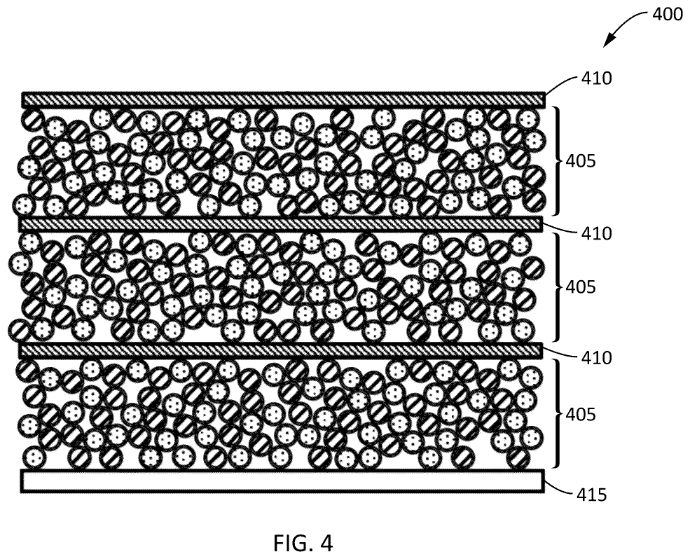

FIG. 4 shows an example of a cross-sectional schematic illustration of the composite thermal insulation. As shown in FIG. 4, the composite 400 includes layers of nanoparticles 405. The composite 400 is shown as having three layers of nanoparticles 405. In some embodiments, the composite 400 includes two, three, four, or more layers of the nanoparticles 405. The layers of nanoparticles 405 may comprise any of the nanoparticle mixtures describe herein. In some embodiments, a layer of nanoparticles 405 is about 300 nm to 5 centimeters (cm) thick.

The layers of nanoparticles 405 are separated by support layers 410. A support layer 410 mechanically supports the layers of nanoparticles 405. In some embodiments, a support layer 410 is about 3 microns to 5 cm thick. In some embodiments, the support layers 410 comprise a metal, PDMS, glass fiber reinforced cellulosic felt, glass fiber, coated or uncoated polymer bonded glass fiber matt facers, or any other suitable polymer. In some embodiments, one side of both sides of each of the support layer 410 has a low emissivity material disposed thereon. The low emissivity material is reflective of thermal photons for the temperature of the target application to be insulated. Such a low emissivity material can act as thermal radiation shield, reducing the amount of heat transferred through composite as thermal radiation. In some embodiments, the low emissivity material is about 30 nm to 500 nm thick. In some embodiments, the low emissivity material is aluminum or nickel.

Returning to FIG. 4, in some embodiments, the composite is disposed on a layer of material 415. In some embodiments, the layer of material is a layer of material from a group a metal foil, polydimethylsiloxane (PDMS), glass fiber reinforced cellulosic felt, glass fiber, and coated or uncoated polymer bonded glass fiber matt. In some embodiments, the layer of material is metal foil that is aluminum foil. In some embodiments, the layer of material (one side or both sides) has a low emissivity material disposed thereon.

While the examples of the composite thermal insulation shown herein are planer layers, the composite thermal insulation can be fabricated and arranged to insulate objects of any geometry. This may include, for example, planar insulation for large flat surfaces, concentric cylindrical insulation for tubes or pipes, and spherical or combined geometry insulation for tanks and vessels. In some embodiments, the composite thermal insulation is flexible and can take the shape of the object for which the insulation is desired.

A high R/inch value composite thermal insulation produced by assembling surface treated or pristine nanoparticles using easy to manufacture and scale up process was described herein. In case of nanomaterials, which have a very high density of interfaces, it is possible to attain low thermal conductivity at high solid volume fraction (>10%), making the insulation mechanically robust. Manufacturing and scale up of nanoparticle-based insulation does not suffer from the limitations of aerogels due to low energy requirements, thereby making them significantly cheaper than acrogels. The insulation, although mechanically robust, could also be arranged to have much more flexibility than VIP so that it can be bent and/or cut into any shape of size.

The following examples are intended to be examples of the embodiments disclosed herein, and are not intended to be limiting.

### EXAMPLES

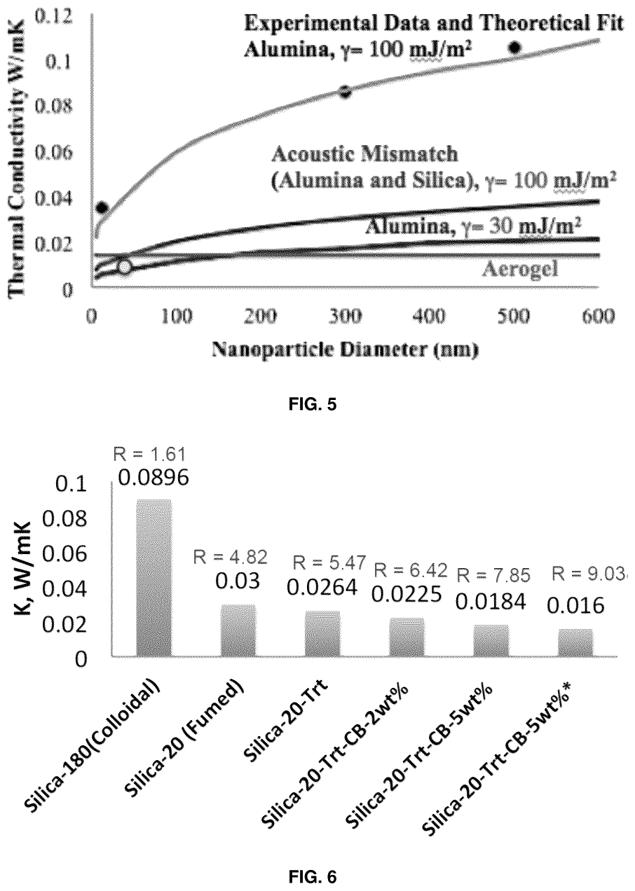

FIG. 5 shows a graph illustrating the effect of surface energy, acoustic mismatch, and nanoparticle size for a packed bed of randomly distributed alumina nanoparticles (volume fraction about 0.6). k of bulk alumina is about 25 W/m-K. The experimental data (dots) in FIG. 5 show that k of the packed nanoparticle bed of alumina nanoparticles is about 3 orders of magnitude less and is close to that of air. This experimental data is compared with the theoretical model given by Eq. (1) and it shows a good match between data and the model. In the theoretical model, k of the air in the space between the nanoparticles was modeled including the Knudesn Effects. Overall k of the packed bed was modeled using the well know Bruggeman model.

FIG. 6 shows the thermal conductively of a number of different thermal insulation composites. FIG. 6 shows effect of various parameters such as the sizes of nanoparticles, the ratio of first nanoparticle to second nanoparticle, the surface treatment by silane, and adjusting the mixing process.

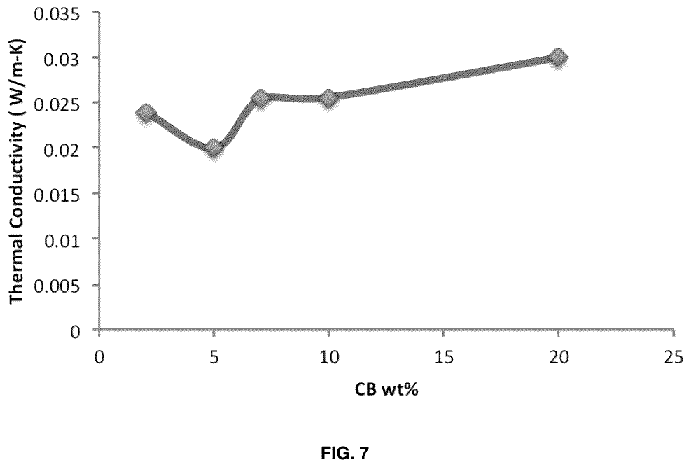

FIG. 7 shows the effect of the ratio of silica/carbon black on the thermal conductivity of a thermal insulation composite. The ratio of first nanoparticles to second nanoparticles may be different for different compositions of nanoparticles.

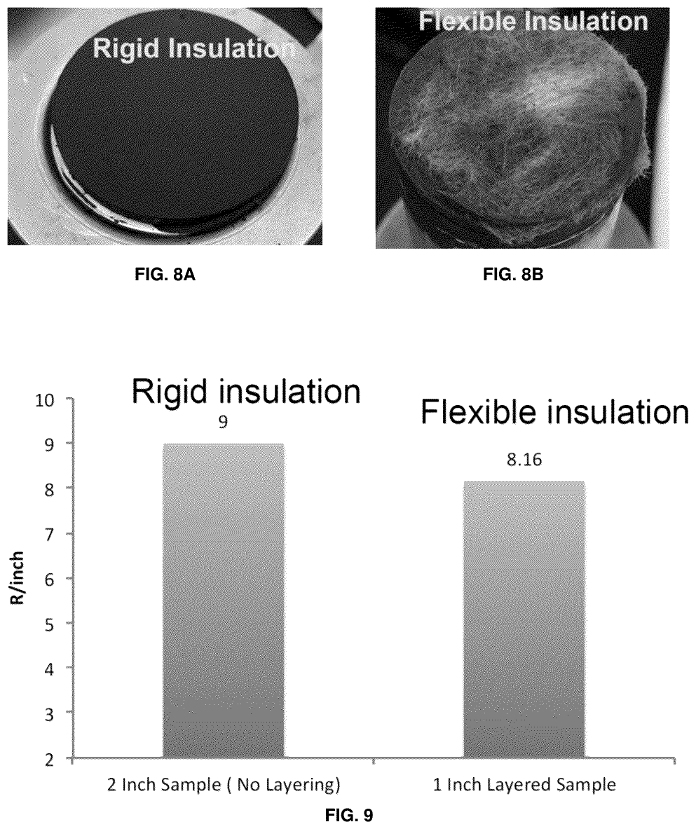

FIG. 8A shows an example of rigid insulation made using one method. FIG. 8B shows an example of flexible insulation made by integrating glassfibers in the method. The insulation included perfluorodecyltrichlorosilane treated fumed silica (with surface area of about 300 m²/g) mixed with about 5 wt % untreated carbon black (with surface area of about 50 m²/g) and compressed into pellet form factor under about 100 psi. The density of the insualtion was about 10 lbs/cu.ft.

FIG. 9 shows the thermal insualtion properties of both the rigid insulation and the flexible insulation shown in FIGS. 8A and 8B, respectively.

### CONCLUSION

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A composite comprising:
a plurality of silica nanoparticles; and
a plurality of first nanoparticles, the plurality of silica nanoparticles comprising about 70 wt % to 98 wt % of the composite, the plurality of first nanoparticles comprising about 2 wt % to 30 wt % of the composite.

2. The composite of claim 1, wherein silica nanoparticles of the plurality of silica nanoparticles are hollow silica nanoparticles.

3. The composite of claim 1, wherein first nanoparticles of the plurality of first nanoparticles are hollow first nanoparticles.

4. The composite of claim 1, wherein each silica nanoparticle of the plurality of silica nanoparticles has a morphology that is spherical to branched to randomly shaped and has a surface area of about 10 m²/g to 800 m²/g, and wherein each first nanoparticle of the plurality of first nanoparticles has a morphology that is spherical to branched to randomly shaped and has a surface area of about 10 m²/g to 800 m²/g.

5. The composite of claim 1, wherein the plurality of first nanoparticles are nanoparticles from a group carbon, alumina, titania, magnesia, zirconia, silicon nitride, iron oxide, and an oxide ore.

6. The composite of claim 1, wherein the composite has a density of about 5 lbs/cubic feet to 40 lbs/cubic feet.

7. The composite of claim 1, wherein the composite has a thermal conductivity of about 0.009 W/m·K to 0.026 W/m·K.

8. The composite of claim 1, wherein at least a portion of the silica nanoparticles of the plurality of silica nanoparticles are covalently bonded to one or more silane molecules having the following structure: 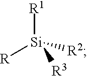
wherein R and R¹ are each independently —(CH₂)ₙ—R⁴, wherein R⁴ is —X, —O—CH₃, or —OH, wherein R² and R³ are each independently —X, —CH₃, or —NH₂, wherein n is an integer from 1 to 20, wherein X is a halogen, and wherein one of R² or R³ of the silane is replaced with a covalent bond to an ether group which in turn is covalently bonded to a silica nanoparticle.

9. The composite of claim 8 wherein the halogen is fluorine, chlorine, or bromine.

10. The composite of claim 1, wherein at least a portion of the first nanoparticles of the plurality of first nanoparticles are covalently bonded to one or more silane molecules having the following structure: 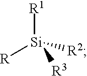
wherein R and R¹ are each independently —(CH₂)ₙ—R⁴, wherein R⁴ is —X, —O—CH₃, or —OH, wherein R² and R³ are each independently —X, —CH₃, or —NH₂, wherein n is an integer from 1 to 20, wherein X is a halogen, and wherein one of R² or R³ of the silane is replaced with a covalent bond to an ether group which in turn is covalently bonded to a first nanoparticle.

11. The composite of claim 10, wherein the halogen is fluorine, chlorine, or bromine.

12. The composite of claim 1, further comprising:
a plurality of second nanoparticles, wherein the plurality of second nanoparticles comprise about 1 wt % to 10 wt % of the composite, and wherein the plurality of second nanoparticles are a different composition than the plurality of first nanoparticles.

13. The composite of claim 12, wherein the plurality of second nanoparticles are nanoparticles from a group carbon, alumina, titania, magnesia, carbon, alumina, titania, magnesia, zirconia, silicon nitride, iron oxide, and an oxide ore.

14. The composite of claim 12, wherein each second nanoparticle of the plurality of second nanoparticles has a morphology that is spherical to branched to randomly shaped and has a surface area of about 10 m²/g to 800 m²/g.

15. The composite of claim 12 wherein at least a portion of the second nanoparticles of the plurality of second nanoparticles are covalently bonded to one or more silane molecules having the following structure: 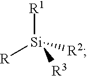
wherein R and R¹ are each independently —(CH₂)ₙ—R⁴, wherein R⁴ is —X, —O—CH₃, or —OH, wherein R² and R³ are each independently —X, —CH₃, or —NH₂, wherein n is an integer from 1 to 20, wherein X is a halogen, and wherein one of R² or R³ of the silane is replaced with a covalent bond to an ether group which in turn is covalently bonded to a second nanoparticle.

16. The composite of claim 15, wherein the halogen is fluorine, chlorine, or bromine.

17. A structure comprising:
a layer of material; and
a composite disposed on the layer of material, the composite comprising:
a plurality of silica nanoparticles; and
a plurality of first nanoparticles, the plurality of silica nanoparticles comprising about 70 wt % to 98 wt % of the composite, the plurality of first nanoparticles comprising about 2 wt % to 30 wt % of the composite.

18. The structure of claim 17, wherein the layer of material is a layer of material from a group a metal foil, polydimethylsiloxane (PDMS), glass fiber reinforced cellulosic felt, glass fiber, and coated or uncoated polymer bonded glass fiber matt.

19. The structure of claim 17, wherein the layer of material is coated with a low emissivity material.

20. A method comprising:
reacting a plurality of silica nanoparticles with a silane having the structure of 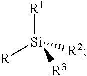
wherein R and R¹ are each independently —(CH₂)ₙ—R⁴, wherein R⁴ is —X, —O—CH₃, or —OH, wherein R² and R³ are each independently —X, —CH₃, or —NH₂, wherein n is an integer from 1 to 20, wherein X is a halogen, using gas phase surface chemistry to generate a plurality of silanized silica nanoparticles, and wherein one of R² or R³ of the silane is replaced with a covalent bond to an ether group which in turn is covalently bonded to a silica nanoparticle;
reacting a plurality of first nanoparticles with a silane having the structure of 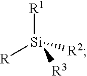
wherein R and R¹ are each independently —(CH₂)ₙ—R⁴, wherein R⁴ is —X, —O—CH₃, or —OH, wherein R² and R³ are each independently —X, —CH₃, or —NH₂, wherein n is an integer from 1 to 20, wherein X is a halogen, using gas phase surface chemistry to generate a plurality of silanized silica nanoparticles, and wherein one of R² or R³ of the silane is replaced with a covalent bonded to an ether group which in turn is covalently bond to a first nanoparticle;
mixing the plurality of silanized silica nanoparticles and the plurality of silanized first nanoparticles to form a mixture, wherein the plurality of silanized silica nanoparticles comprise about 70 wt % to 98 wt. and wherein the plurality of silanized first nanoparticles comprise about 2 wt % to 30 wt %; and
compacting the mixture to a specified density.
